(19) United States
(12) Patent Application Publication
(10) Pub. No.: US 2018/0338504 A1
(43) Pub. Date: Nov. 29, 2018

(54) AUTOMATED MADE TO ORDER FOOD PREPARATION DEVICE AND SYSTEM

(71) Applicants: Ghanshyam Lavri, Etobicoke (CA); Bijendra K Sharma, Lanigan (CA)

(72) Inventors: Ghanshyam Lavri, Etobicoke (CA); Bijendra K Sharma, Lanigan (CA)

(21) Appl. No.: 15/989,577

(22) Filed: May 25, 2018

Related U.S. Application Data
(60) Provisional application No. 62/511,059, filed on May 25, 2017.

(51) Int. Cl. A21B 7/00; G05B 15/02; A21B 5/00; A21C 3/02; A21C 9/04; A21C 15/04; A21C 9/08

(52) U.S. Cl. CPC A21B 7/00; G05B 15/02; A21B 5/00; A21D 13/41; A21C 9/04; A21C 15/04; A21C 9/08; A21C 3/02

(57) ABSTRACT

An automated pizza making system, comprising: a computer-based controller; an ordering system; automated food handling devices; racks; toppings stations; ovens; cutting stations, and packaging stations. Conveyors and/or automated food handling devices move the pizzas between the racks, the topping stations, the ovens, the cutting stations, and the packaging stations, such that made to order pizzas are created without being handled by human hands. The toppings stations may comprise sauce stations, cheese stations, and meat/veggie topping stations. The ordering system may be configured to allow a plurality of customer orders and the computer-based controller is configured to process the orders, such that the automated pizza ordering system produces made to order pizzas that are picked up or delivered.

### CROSS-REFERENCE TO RELATED APPLICATION

This application claims the benefit of U.S. Provisional Application No. 62/511,059, filed on May 25, 2017, entitled “The Automated Computer Controlled Pizza Machine”, the contents of which are incorporated herein by reference as though set forth in their entirety.

### FIELD OF USE

The present disclosure relates generally to food manufacturing equipment, and more particularly to an automated pizza preparation device that includes robotic portions and automated dispensing devices for preparing and cooking customized and made-to-order pizzas.

### BACKGROUND

Before the device and system of the present disclosure, made-to-order pizzas were inadequate, inconsistent, time consuming to make, and difficult to cost control. Specifically, pizzas generally have either too much or too little toppings, are poorly balanced due to human interaction, and setup time takes too long, all of which raises production and operating costs.

It is possible to overcome some of these deficiencies by automation, but current automation does not allow for making to order, baking to order, cutting to order, and packing to order. Accordingly, most automation is seen in the frozen pizza sector, where pizzas use automation, but are not made to order or baked to order. Instead, the user must bake and cut the pizza themselves.

All made-to-order pizzas that are created today are made by hand, which requires a lot of time between ordering and baking. Time is money, so this labor cost increases the cost of the pizza. Additionally, human error and lack of oversite may cause the pizza to have either too few or too many toppings, which, respectively cheats the customers or raises costs. Currently, there is no way to provide made-to-order fully customized slices.

Removing the mostly human element from making a made-to-order pizza, through automation, may result in a shorter wait time for the customer, reduced set up time, better quality control, and better use of capital investment funds.

Therefore, there remains a long felt need in the art for an automated pizza slice and pizza pie device that is both flexible and creates made to order pizzas.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to an automated pizza making machine that makes made-to-order pizzas with minimal human interaction.

The automated machine and system of the present disclosure may be configured to reduce material handling, transit time, reduce prep time, more efficiently use space, increase quality control, reduce costs, reduce work-in-process inventory, reduce customer wait times, minimize clean up, and minimize hygiene issues.

The automated machine and system of the present disclosure may be modular and may comprise various conveyers, material handlers, racks, robotic arms and transfer platforms, scales, sensors, ovens, cutters, electronic data processing units (computers and chips), proprietary software, and food loaders.

The automated machine and system of the present disclosure may allow the customer to order a single slice of pizza or an entire pizza pie. The system may also allow the customer the flexibility to select exactly what toppings to put on each slice of the pizza, select from one of several pizza diameters, and select how many slices are in each pie.

The primary human interaction with the automated machine and system of the present disclosure is filling the various ingredient containers with the fresh and raw ingredients into the proper compartments.

One embodiment may be an automated pizza making system, may comprise: a computer-based controller; an ordering system; one or more automated food handling devices; one or more racks; one or more toppings stations; and one or more ovens; wherein the one or more automated food handling devices may move a plurality of pizzas between the one or more racks, the one or more topping stations, and the one or more ovens, such that the plurality of pizzas are not handled by human hands; wherein each of the one or more toppings stations comprise one or more sauce stations, one or more cheese stations, and one or more meat/veggie topping stations; wherein the ordering system may be configured to allow a plurality of customer orders of the plurality of made to order pizzas; and wherein the computer-based controller may be configured to process the plurality of customer orders, such that the automated pizza ordering system produces the plurality of made to order pizzas. The automated pizza making system further may comprise: one or more cutting stations. The automated pizza making system further may comprise: one or more packaging stations. The automated pizza making system further may comprise: one or more delivery/pick up stations. The automated pizza making system further may comprise: a dough feeder; and a dough flattener. The one or more automated food handling devices may move the plurality of pizzas between the one or more ovens, the one or more cutting stations, and the one or more delivery pick up stations. The one or more automated food handling devices may move the plurality of pizzas between the dough feeder, the rack, and the one or more toppings stations. The dough flattener may produce a plurality of flattened dough that may be moved by the one or more automated food handling devices to the one or more toppings stations; and the one or more toppings stations may apply at least one pizza topping from the one or more sauce stations, the one or more cheese stations, and the one or more meat/veggie stations, to the plurality of flattened dough, such that the plurality of made or order pizzas may be created. The plurality of made to order pizzas may be moved from the one or more toppings stations to the one or more ovens. The plurality of made to order pizzas may be moved from the one or more toppings stations to the one or more packaging stations. The ordering system may be configured to allow, and the one or more toppings station and the computer-based controller may be configured to provide, a plurality of customers to customize the plurality of customer orders, including only applying a sauce, a cheese, and one or more pizza toppings on only a portion of an ordered pizza. The ordering system may be selected from the group of ordering systems consisting of a website and a mobile software application; wherein the one or more packaging stations may be configured to package the plurality of made to order pizzas in at least one package selected from the group of packages consisting of: cardboard boxes; plastic wrap; and insulating packaging; wherein the one or more cutting stations may be configured to cut the plurality of made to order pizzas in at least two different cut styles. Each of the one or more racks may be multilevel and automated, such that the one or more racks may be controlled by the computer-based controller. The one or more ovens each may comprise a stone conveyor. The one or more toppings stations further may comprise one or more spice stations. Each of the one or more meat/veggie toppings stations comprise one or more toppings dispensers and one or more agitated chutes; wherein each of the one or more toppings dispensers may comprise a container, a blade, a portion space, and a gate; and wherein each of the one or more toppings dispensers may dispense one or more meat/vegetable toppings in an even and consistent manner.

Another embodiment may be an automated pizza making system, which may comprise: a computer-based controller; an ordering system; one or more automated food handling devices; one or more racks; one or more toppings stations; one or more ovens; one or more cutting stations; one or more packaging stations; and one or more delivery/pick up stations; wherein the one or more automated food handling devices may move a plurality of pizzas between the one or more racks and the one or more topping stations; wherein the one or more automated food handling devices may move the plurality of pizzas between the one or more ovens, the one or more cutting stations, and the one or more delivery pick up stations. wherein each of the one or more toppings stations may comprise one or more sauce stations, one or more cheese stations, and one or more meat/veggie topping stations; wherein each of the one or more meat/veggie toppings stations may comprise one or more toppings dispensers and one or more agitated chutes; wherein each of the one or more toppings dispensers may comprise a container, a blade, a portion space, and a gate; wherein the one or more toppings stations apply at least one pizza topping from the one or more sauce stations, the one or more cheese stations, and the one or more meat/veggie stations, to a plurality of flattened dough, such that the plurality of made or order pizzas may be created; wherein the ordering system may be configured to allow a plurality of customer orders of the plurality of made to order pizzas; wherein the computer-based controller may be configured to process the plurality of customer orders; wherein the plurality of made to order pizzas may be moved from the one or more toppings stations to the one or more ovens; wherein the plurality of made to order pizzas may be moved from the one or more ovens to the one or more cutting stations; wherein the plurality of made to order pizzas may be moved from the one or more cutting stations to the one or more packaging stations; wherein each of the one or more racks may be multilevel and automated, such that the one or more racks may be controlled by the computer-based controller. The automated pizza making system further may comprise: a dough feeder; and a dough flattener; wherein the one or more ovens may each comprise a stone conveyor; wherein the one or more toppings stations further may comprise one or more spice stations. The plurality of made to order pizzas may be moved from the one or more toppings stations to the one or more ovens by one or more transfer devices selected from the group of transfer devices consisting of: conveyors and automated food handling devices.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the automated pizza making system.

FIG. 2 is an illustration of a top view of one embodiment of the automated pizza making system showing an automated conveyor.

FIG. 3 is an illustration of a side view of the automated pizza making system shown in FIG. 2.

FIG. 4 is an illustration of a top view of another embodiment of the automated pizza making system showing a pick and place handling system.

FIG. 5 is an illustration of a side view of the automated pizza making system showing a portion of the system shown in FIG. 4.

FIG. 6 is an illustration of a top view of another embodiment of the automated pizza making system showing a pick and place handling system.

FIG. 7 is an illustration of a top view of one embodiment of the automated pizza slice making system showing an automated conveyor.

FIG. 8 is an illustration of a side view of the automated pizza slice making system shown in FIG. 7.

FIG. 9 is an illustration of a side view of one embodiment of a pizza toppings dispenser.

FIG. 10 is an illustration of a top view of one embodiment of a pizza toppings dispenser.

FIG. 11 is an illustration of a top view of another embodiment of a pizza toppings dispenser showing a gate.

FIG. 12 is an illustration of a side view of another embodiment of a pizza toppings dispenser.

FIG. 13 is an illustration of a side view of another embodiment of a pizza toppings dispenser.

FIG. 14 is an illustration of a side view of one embodiment of a meat/veggie dispensing station.

FIG. 15 is an illustration of a top view of another embodiment of the automated pizza making system showing a pick and place handling system.

### DETAILED DESCRIPTION OF ILLUSTRATIVE EMBODIMENTS

In the following detailed description of various embodiments, numerous specific details are set forth in order to provide a thorough understanding of various aspects of one or more embodiments. However, the one or more embodiments may be practiced without some or all of these specific details. In other instances, well-known methods, procedures, and/or components have not been described in detail so as not to unnecessarily obscure aspects of embodiments.

While multiple embodiments are disclosed, still other embodiments of the present disclosure will become apparent to those skilled in the art from the following detailed description, which shows and describes illustrative embodiments. As will be realized, the embodiments are capable of modifications in various obvious aspects, all without departing from the spirit and scope of the present disclosure. Accordingly, the graphs, figures, and the detailed descriptions thereof, are to be regarded as illustrative in nature and not restrictive. Also, the reference or non-reference to a particular embodiment shall not be interpreted to limit the scope.

Before the embodiments are disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signify both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

The term “pizza” may refer to a pizza pie, of any size, an individual pizza slice, a pizza dough slice, a pizza pie dough, and/or a pizza or pizza slice in any stage of preparing and building a completed pizza.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

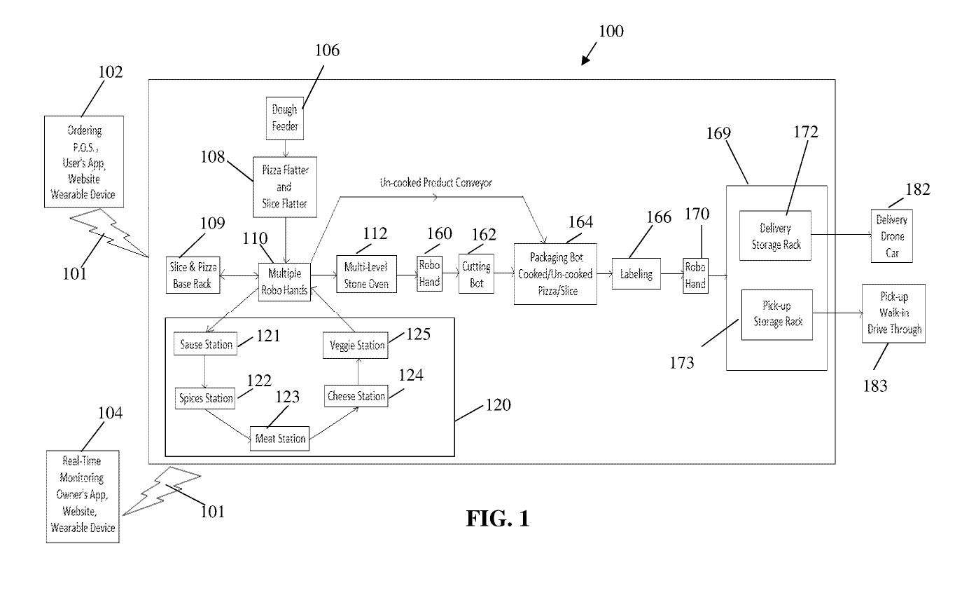

FIG. 1 is a flow chart of one embodiment of the automated pizza making system. As shown in FIG. 1 the automated pizza making system 100 may be in wired or wireless communication 101 with an ordering system 102 and/or a monitoring/control system 104. The automated pizza making system 100 may comprise dough feeder 106, which may make and process freshly made dough, wherein the dough may be weighed and cut according to the order. The dough feeder 106 may either accept dough or dough ingredients (which may be formed into dough by the dough feeder. The dough is passed to a flattener 108 that shapes and flattens the dough into a pie round, pie slice, or other shape. The formed and flattened dough may then be immediately processed or stored on a rack 109 to later process. Preferably, the dough may be plated on an aluminum plate that may then be used to more easily handle, transport, and transfer the pizza from station to station. In a preferred system, a number of pie doughs, round and slice, may be premade, in accordance with predictive modeling, so that the system is primed with doughs that are ready to receive toppings as soon as the order is placed.

The dough feeder 106 is preferably above the flattener 108 so that the dough may be dropped or gravity passed to the flattener 108 from the feeder 106.

The automated pizza making system 100 may further comprise a first automated food handling device 110 that is configured to move the dough to and from the flattener

108, an oven 112, the rack 109, and/or toppings station 120. The toppings station 120 may comprise a sauce station 121, spices station 122, meat station 123, cheese station 124, and veggie station 125.

In one embodiment, the automated food handling device 110 may comprise one or more pizza peels that are at the end of an articulated robotic arm. Preferably each arm of the automated food handling device 110 may rotate, or pivot, such that it can engage with the flattener 108, the oven 112, the rack 109, and/or the toppings station 120. In some embodiments the rack 109 may be a wire, multi-level rack that may be used to store flattened dough and topped pies that are ready to bake. This may be useful in the event that the oven gets backed up.

The pizza peels are preferably slotted to reduce weight and may be specifically configured to slide under the dough or plates and move the pies and slices (plated or not) from station to station.

The toppings station 120 is preferably an automated and robotic station that moves the slice or pie to each station in sequence. Alternatively, the pie may be moved out of sequence if desired through programming. FIG. 1 shows one embodiment, wherein the pies and slices go to the sauce station 121 and then are moved to the spices station 122. The sauce station 121 may use a robotic food dispenser to evenly and substantially cover the dough with an appropriate amount of pizza sauce. In some embodiments, the pizza sauce may be substituted for other types of sauce such as buffalo sauce, ranch sauce, barbeque sauce, or any other special sauce. In some embodiments, the ordering application may allow the user to select one or more spices to be added to the pizza, such as standard, spicy, sugar, salt, red chilis, black pepper, garlic, basil, oregano, lemon, and the like. The spices may be loaded into containers that are connected to or part of a robotic food dispenser that evenly dispenses an appropriate amount of the selected spices.

The pizza may move from station to station by use of a conveyor belt, a series of conveyors, and/or the automated food handling device 110. The pie may be moved to the meat station 123. The meat station 123 may have between one and eight different types of meat, but may usually have pepperoni, sausage, bacon and ham. Other meats that might be used include salami, meatballs, chicken, Canadian bacon, anchovies, shrimp, and other cured meats. Preferably, the meat is cut, portioned, and then evenly dispensed on the pie or slice, as ordered. The toppings may also be configured to be dispensed onto only a portion of the pizza pie, such as on only one slice or half of the pie.

The pie may be moved to the cheese station 124, which may be an automated dispenser that may be loaded with pre-shredded, crumbled cheese, or a solid block of cheese and shredded as ordered. The cheese may be dispensed evenly on the pizza. No, Standard, Extra, or Double Cheese may be selected and dispensed. In some embodiments the cheese may be a blend of cheeses and may be freshly shredded to order. In other embodiments, the cheese may be added to slices that are pre-sliced or sliced to order.

The pie may be moved to the veggie station 125, which may evenly, and as-ordered, dispense vegetables via automated food dispensers. The veggie station 125 may have between one and eight different types of vegetables, but may usually have onion, tomato, bell peppers, mushroom, and black olives. Other vegetables that might be used include pineapple, artichoke, green olives, pepperoncini, fresh garlic, fresh basil, jalapenos, and the like. Preferably, the vegetables are cut, portioned, and then evenly dispensed on the pie or slice, as ordered. The toppings may also be configured to dispensed onto only a portion of the pizza pie, such as on only one slice or half of the pie. Pre-cut vegetable can be used, but this may reduce the shelf life of the vegetables.

Once the pie is topped, it may be stored on the rack 109 or moved to the oven 112. The oven 112 may be a speed adjustable, multi-level conveyor oven. Preferably, the user may order the pizza uncooked, regular, crispy, or under baked. Depending on the order, the pizza may skip the oven 112, baked standard, baked long (slower conveyor speed) or baked fast (faster conveyor speed). The multiple levels allow more pizzas to be baked on the same footprint of space. The oven conveyor may have a stone conveyor to allow for optimal crust and energy efficiency. The heat may be provided by gas, electric, or infrared. Preferably a standard pie may take less than five minutes to bake.

If the pizza is unbaked, or after it is finished baking, the automated food handling device 110 or a second automated food handling device 160 may be used to move the pizza to the cutting station 162 and/or packing station 164. The pizza may be sliced regular (6 or 8 slices), none, or double (12 or 16). If the pizza is a slice, the cutter is not engaged. The pizza packaging, which may usually be a box if cooked, or plastic wrap if uncooked, may be labeled by labeler 166 to identify the purchaser and pizza type. The label may specifically include customer name, phone number, address, barcode, and product details like toppings, size, extra cheese, 30% extra salt, 15% extra sugar, crispy, and the like. The packaging automated module may use sensors to determine whether the pizza is cooked and what type of packaging it needs.

As shown in FIG. 1, a third automated food handling device 110 may then move the finalized pizza to a completed station 169 be delivered 172 or picked up 173. The delivery pizzas may be delivered by a delivery car service or drone 182. The pickup pizzas may be picked up by the ordering party 183 by car or walk up.

Preferably, the automated pizza making system 100 is controlled by a controller 104 that includes a software program that oversees and monitors all facets of the system 100. The controller 104 may be in electrical communication with all of the automated food handling devices 110, 160, 170, the topping stations, and all conveyor belts. This allows the system 100 to efficiently move, from station to station, the dozens or even hundreds of pizzas that might in process from dough to packaging. The user may access the computer-based controller, program the system, and monitor the status of the pizzas being made through a dedicated interface, website, or mobile device. The customer may also see their made-to-order pizza being prepared in real-time via cameras in the pizza preparation area through the customer's internet enabled devices, so as to confirm sanitary conditions.

The customer interface 102 may be a website, computer program, or mobile device software application. The interface 102 may present the user with the ability to build, order, and have delivered a made to order pizza. The user may use a wizard type interface to select whether they want a slice or an entire pie. If a whole pie, a variety of sizes might be available. The user may then select a variety of toppings and option including, but not limited to:
sauce, no sauce, light sauce, or extra sauce
spice selections
cheese, no cheese, light cheese, extra cheese, or double cheese
onions, tomato, bell pepper, hot pepper, mushrooms, pineapple, and/or olives
ham, bacon, sausage, and/or pepperoni
toppings on a specific portion of the pizza or on the whole pie, and in specific desired quantities
long bake, under bake, standard bake, or no bake
delivery or pick up

Once all of the options are selected, the user may finalize and pay for the order. The order is received by the computer-based controller 104, the pizza is made to order by the automated pizza making system, and then delivered or made available for pick up. The interface 102 may inform the user as to the status of the pizza. The system 100 may also comprise a tracking functionality to keep track of orders placed and pizzas made, such that all pizzas prepared by the system 100 are recorded for future records, and all interactions with the system 100 are recorded, such as number of times individuals enter the system 100, and all the individuals interactions with the system 100.

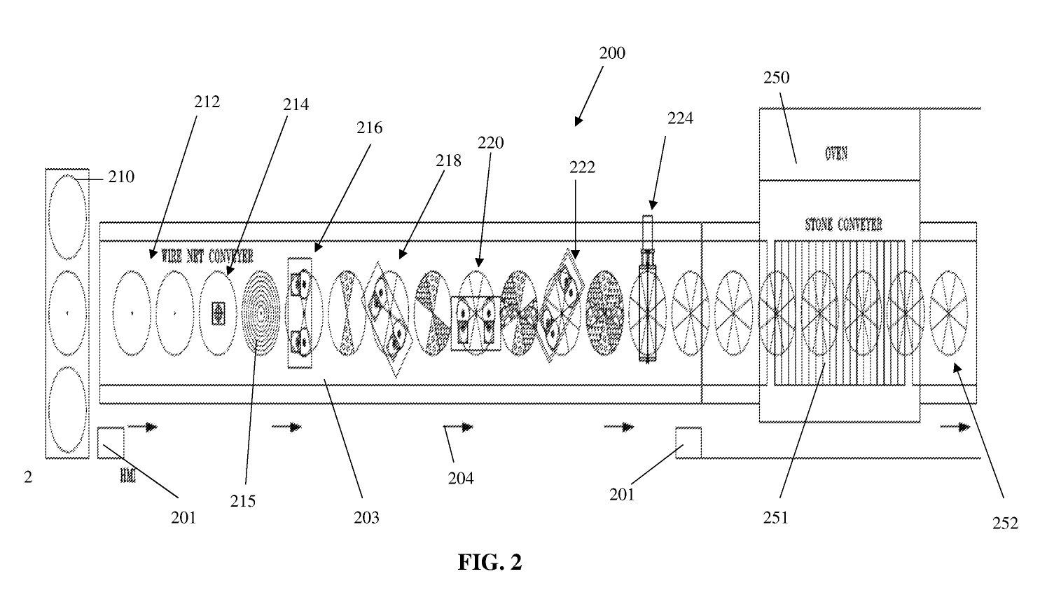

FIG. 2 is an illustration of a top view of one embodiment of the automated pizza making system showing an automated conveyor. As shown in FIG. 2, the automated pizza making system 200 may be set up as a linear assembly line that is configured to make pizza pies. Although the system 200 may be configured to build slices and pies, it is shown as specifically making pies. Although only one size of pies is shown, the pies may be several different sizes.

The system 200 may have a controller interface 201 that allows an onsite user to monitor, control, and program the system in a real-time basis. After a user orders a pizza, the system moves a formed and flattened pie dough from a rack 210 (or creates a formed and flattened pie dough) and moves it to the conveyor 203. The conveyor 203 is configured to steadily and/or in a stop and go manner, move a plurality of pies in a linear direction 204. The pizza pie dough may be moved from the rack 210 to the start 212 of conveyor 203 via an automated food handling device, which may be one or more robotic arms with a pizza peel or other flat hand pizza or plate handling tip. The pizza pies may directly contact the conveyor 203 surface or may be on a plate.

FIG. 2 shows that the conveyor 203 may move the pies to the sauce station 214. The pizza 215 shows the sauce having been applied in an even and consistent manner to the pie. The pie then moves to a series of topping stations 216, 218, 220, 222, which may have one or more (in this case, two) topping dispensers at each station 216, 218, 220, 222. The dispensers are configured to apply the selected toppings to the pie as ordered. Although two dispensers are shown at each station 216, 218, 220, 222, only one or many more than two may be used. The toppings dispensed at stations 216, 218, 220, 222 are typical meat and vegetable toppings. The stations may use sensors, such as optical sensors, to ensure that the toppings are only applied to the portions of the pizza specified by the consumer. These sensors, which may be part of any or all parts to the systems 100, 200, may ensure that the dough pies and slices are in the proper position and that the sauce, cheese, and toppings are not dispensed to a misaligned pizza, which would be very wasteful and create a mess. After the toppings are dispensed, the pie moves to the cheese station 224, which evenly dispenses the cheese. The pies may then be baked in the oven 250 on the stone conveyor 251. The pies may then be removed 252, cut, packaged, and/or delivered. The only human hands that touch the pizza itself may belong to those that eat the pizza.

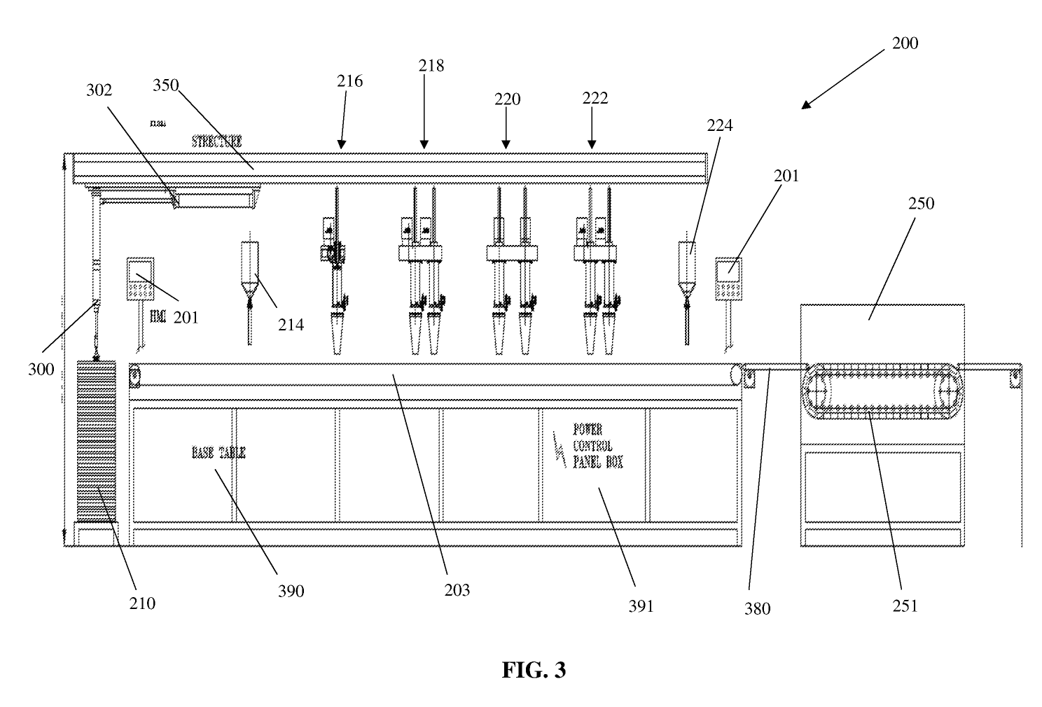

FIG. 3 is an illustration of a side view of the automated pizza making system shown in FIG. 2. FIG. 3 shows that an automated food handling device 300 may be used to move the pizzas from one station to another, such as from the rack 210 to the conveyor 203. The automated food handling device 300, as shown, may be robotic articulating arm that is attached to structure 350 at connector 302. FIG. 3 shows that topping stations 216, 218, 220, 222 are connected to structure 350 which is above conveyor 203. The conveyor 203 may be supported by table 390, which may have power and control components 391. FIG. 3 shows how the system may bridge the gap 380 between the stone conveyor 251 of oven 250 and conveyor 203.

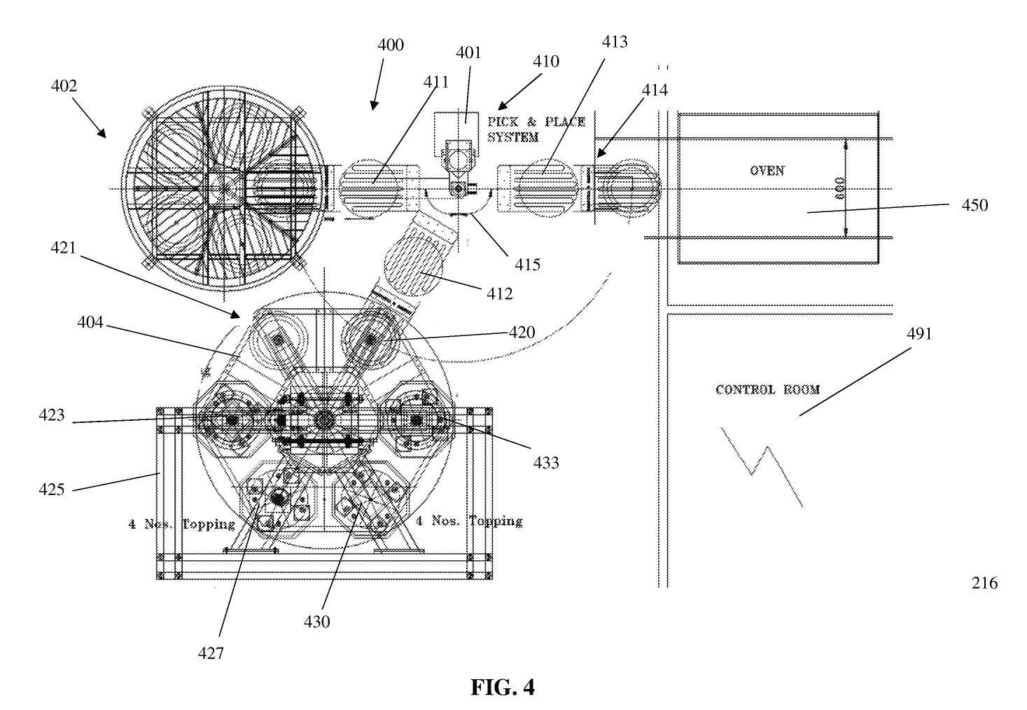

FIG. 4 is an illustration of a top view of another embodiment of the automated pizza making system showing a pick and place handling system. As shown in FIG. 4, the automated food handling device 410 may be a pick and place robotic system comprising a rotational robotics base 401 and pizza peel hands 411, 412, 413. The hands 411, 412, 413 may be on articulating arms that may telescopically extend 414 and rotate 415. This allows the automated food handling device 410 to move the pizza pies and slices between the rack 402, toppings station 404, and oven 450. FIG. 4 shows how the system 400 can be configured as a hub and spoke configuration, rather than a long assembly line. This allows the user to put all of the machines of the system in a small space.

FIG. 4 shows that the rack 402 may be multi-level, circular, and automated. In this manner, the controller 491 may move the rack 402 to allow the automated food handling device 410 to access the appropriate dough slice or dough pie, or to present an open space for the automated food handling device 410 to place a pie or slice.

FIG. 4 shows that the toppings station 404 may have a sauce dispenser 420, which may be the starting and ending position of station 404. The topping station 404 may rotate the pizzas counterclockwise to each station, including cheese station 421, first veggie/meat dispensing station 423, second dispensing veggie/meat station 427, third veggie/meat dispensing station 430, and fourth veggie/meat dispensing station 433. To the extent that each pizza does not need the toppings at a particular station, no toppings are dispensed. After the toppings are dispensed, the pizza is moved to the sauce station and then removed by the automated food handling device 410. The topped pizza may then be baked, stored, or packaged, all within the confines of the system.

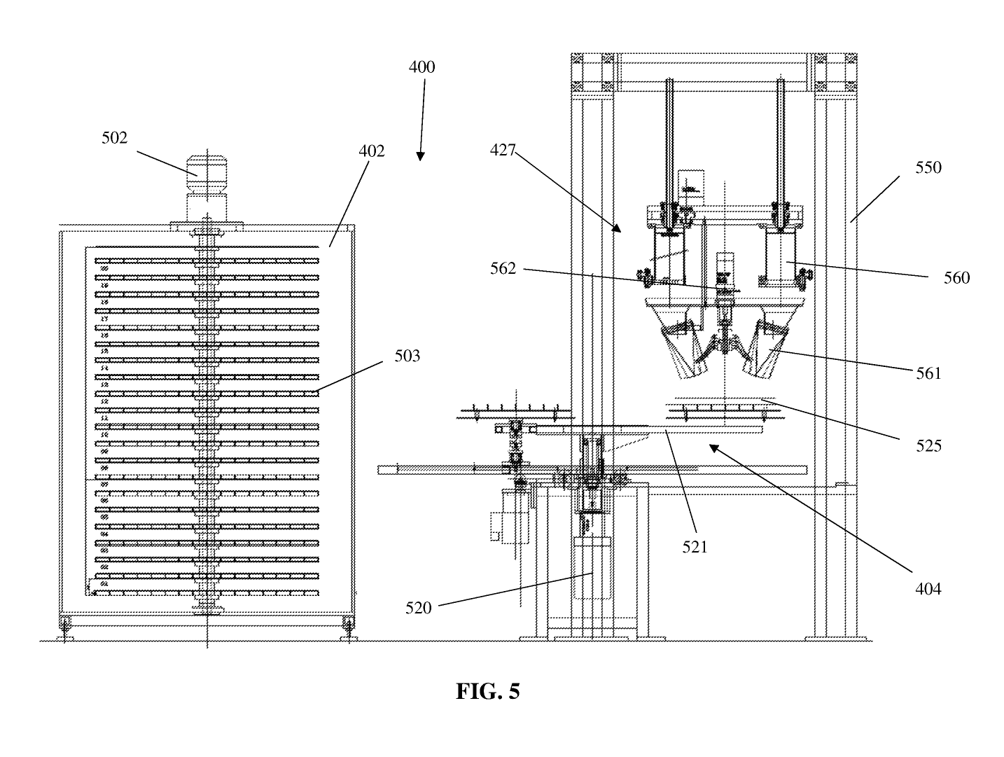

FIG. 5 is an illustration of a side view of the automated pizza making system showing a portion of the system shown in FIG. 4. As shown in FIG. 4, the pizza making system 400 may comprise a rack 402, toppings station 404, optical sensors, and sensors. The rack 402 may be a multilevel rotating rack with a rotational motor 502 and levels 503. As shown in FIGS. 4 and 5 each level may hold 5 pies, five plates, or even more slices. Each rack 402 level 502 may be configured to hold any number of pizzas or slices. The substantially cylindrical shape of the rack 402 allows for a central axis rotation and small footprint, while allowing for a large number of pies and dough to be prepped and stored until the oven is available. Due to a minimum cook time, the oven is likely to be the bottle neck of the system, so the system 400 is configured to ensure that a constant stream of pizzas flow into and out of the oven during peak demand times.

The topping station 404 may comprise rotating platform 521, motor 520, structure 550, and second veggie/meat station 427. Second veggie/meat dispensing station 427 may comprise one or more food containers/dispensers 560, optical sensors, sensors, agitating food chutes 561, and station controller/motor 562. The food containers/dispensers 560 may be filled with toppings that are portioned, cut, and dispensed to the agitating food chutes 561, which agitate to ensure that the toppings are dispensed and distributed on the pizza in an even manner. The controller/motor 562 may rotate or move the chutes 561 to be over the slice, pie, or portion of the pie 525 that is to receive the toppings.

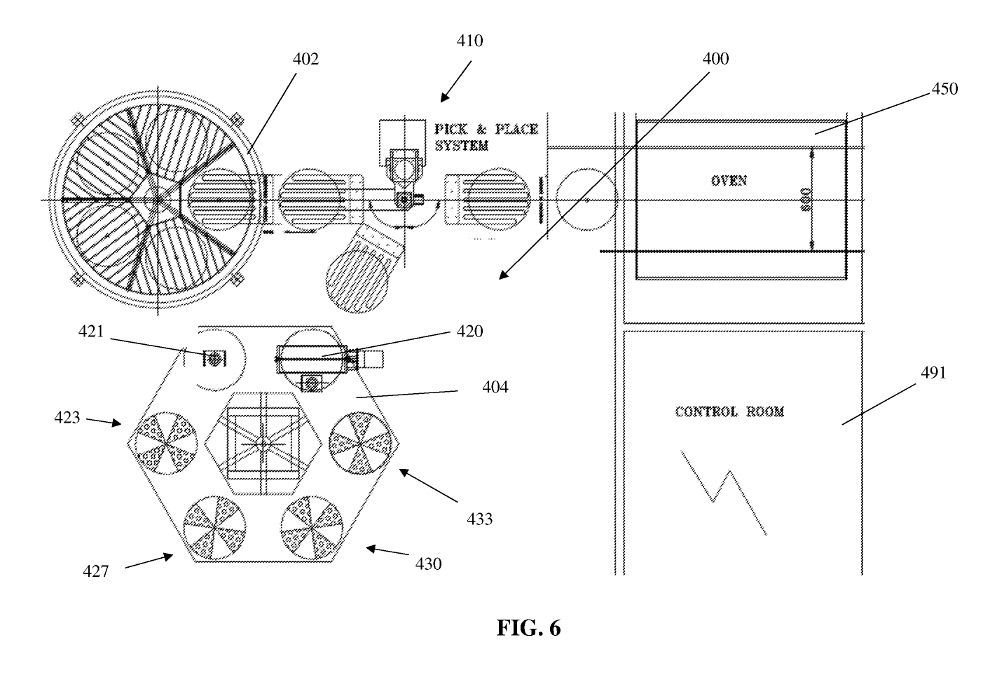

FIG. 6 is an illustration of a top view of another embodiment of the automated pizza making system showing a pick and place handling system. As shown in FIG. 6, the automated food handling device 410 may be a pick and place robotic system comprising a rotational robotics base/controller 401 and pizza peel hands for handling flat food, such as pizza. The hands may be on articulating arms that may telescopically extend and rotate. This allows the automated food handling device 410 to move the pizza pies and slices between the rack 402, toppings station 404, and oven 450. FIG. 6 shows how the system 400 can be configured as a hub and spoke configuration, rather than a long assembly line. This allows the user to put all of the machines and/or modules of the system in a small space. FIG. 6 shows that the rack 402 may be multi-level, circular, and automated. In this manner, the computer-based controller 491 may move the rack 402 to allow the automated food handling device 410 to access the appropriate dough slice or dough pie, or to present an open space for the automated food handling device 410 to place a pie or slice. FIG. 6 shows that the toppings station 404 may have a sauce dispenser 420, which may be the starting and ending position of station 404. The topping station 404 may rotate the pizzas counterclockwise to each station, including cheese station 421, first veggie/meat station 423, second veggie/meat station 427, third veggie/meat station 430, and fourth veggie/meat station 433. To the extent that each pizza does not need the toppings at a particular station, no toppings are dispensed. After the toppings are dispensed, the pizza is moved to the sauce station and then removed by the automated food handling device 410. The topped pizza may then be baked, stored, or packaged, all within the confines of the system.

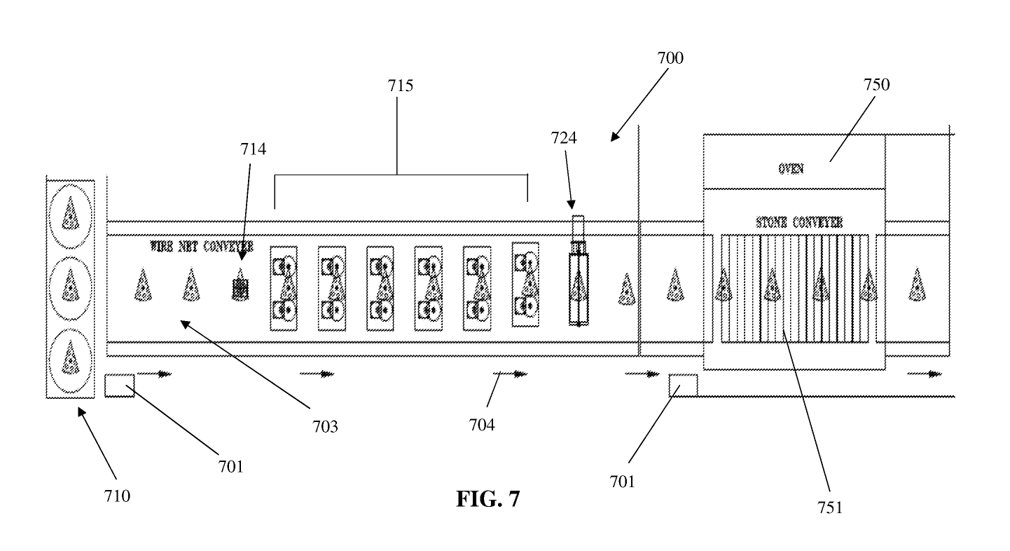

FIG. 7 is an illustration of a top view of one embodiment of the automated pizza slice making system showing an automated conveyor. As shown in FIG. 2, the automated pizza making system 700 may be set up as a linear assembly line that is configured to make pizza slices. Although the system 700 may be configured to build slices and pies, it is shown as specifically making slices. Although only one size of slices is shown, the slices may be several different sizes.

The system 700 may have a controller interface 701 that allows an onsite user to monitor, control, and program the system in a real-time basis. After a user orders a pizza, the system moves a formed and flattened slice dough from a rack 710 (or creates a formed and flattened slice dough) and moves it to the conveyor 703. The conveyor 703 is configured to steadily and/or in a stop and go manner, move a plurality of slices in a linear direction 704. The pizza slice dough may be moved from the rack 710 to the start 712 of conveyor 703 via an automated food handling device, which may be one or more robotic arms with a pizza peel or other flat hand pizza or plate handling tip. The pizza slices may directly contact the conveyor 703 surface or may be on a plate.

FIG. 7 shows that the conveyor 703 moves the slices to the sauce station 714. The slice then moves to a series of topping stations 715, which may have one or more (in this case, two) topping dispensers at each station 715. The dispensers are configured to apply the selected toppings to the slice as ordered. Although two dispensers are shown at each station 715, only one or many more than two, may be used. The toppings dispensed at stations 715 are typical meat and vegetable toppings. The stations may use sensors, such as optical sensors, to ensure that the toppings are only applied to the portions of the pizza specified by the consumer. These sensors, which may be part of any or all parts to the system 100, 200, 400, 700 may ensure that the dough slices and slices are in the proper position and that the sauce, cheese, and toppings are not dispensed to a misaligned pizza, which would be very wasteful and create a mess. If the system senses that the pie or slice is not in the correct position an alarm may sound or the system 100, 200, 400, 700 may control the conveyors or automated food handling devices to move the pies or slices into the proper position. After the meat and vegetable toppings are dispensed, the slice moves to the cheese station 724, which evenly dispenses the cheese. The slices may then be baked in the oven 750 on the stone conveyor 751. The slices may then be removed, cut, packaged, and/or delivered. The only human hands that touch the pizza itself may belong to those that eat the pizza. In other embodiments, the cheese station 724 may be before or in between the stations 715.

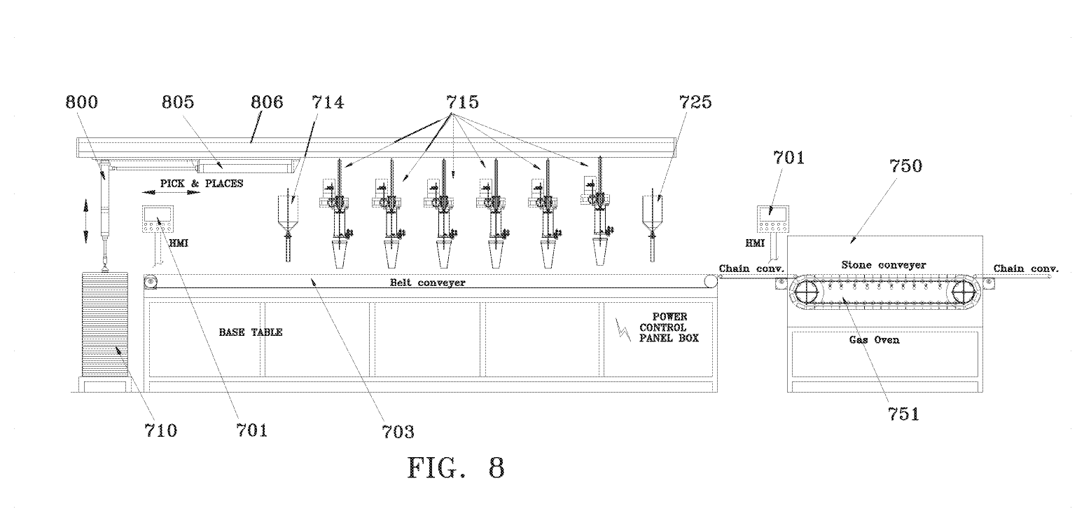

FIG. 8 is an illustration of a side view of the automated pizza slice making system shown in FIG. 7. FIG. 8 shows that an automated food handling device 800 may be used to move the pizza slices from one station to another, such as from the rack 710 to the conveyor 703. The automated food handling device 800, as shown, may be robotic articulating arm that is attached to structure 850 at connector 802. FIG. 8 shows that topping stations 715 may be connected to structure 850 which is above conveyor 703.

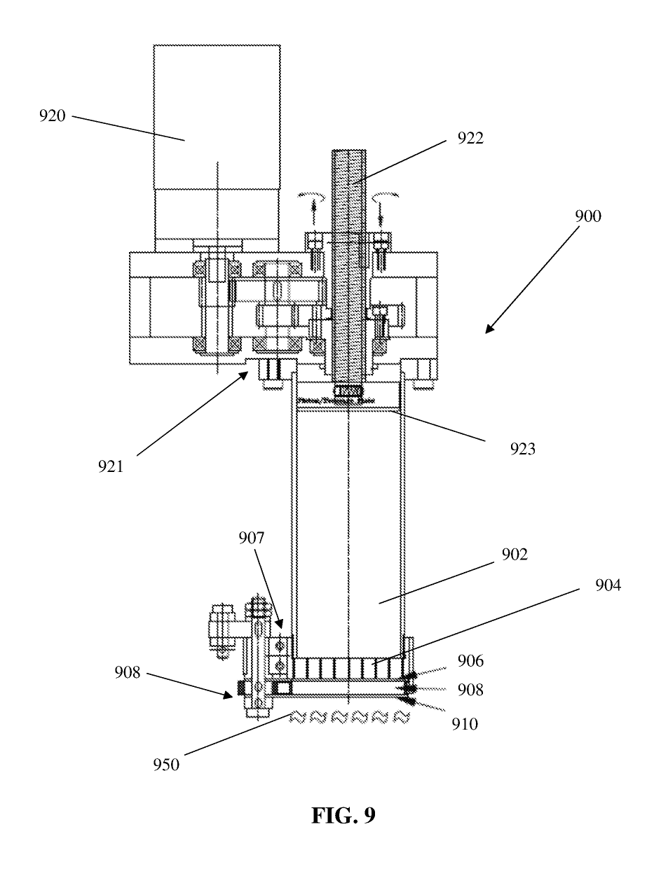

FIG. 9 is an illustration of a side view of one embodiment of a pizza toppings dispenser. As shown in FIG. 9, the food dispenser 900, which may be a pizza toppings dispenser, may comprise a food container 902, a vertical cutting grid 904, a pivoting blade 906, a dispenser portion cup 908 (or space), a gate 910, blade controller 907, gate controller 908, motor 920, gear box 921, and threaded pressure piston 922. The container 902 may be configured to hold pizza toppings that are loaded by the operator. The room in which the dispenser 900 is in is preferably in a low temperature and low humidity room, so that the toppings stay fresh. The toppings may be prepped, such as removing skins, stems, wrappings, and the like, but preferably the toppings are sliced to order by the dispenser 900. Pre-sliced toppings may be used, but this reduces the shelf life of the toppings and reduces the time savings gained by prepping to order. The toppings may be kept very cold and vacuumed wrapped until use to extend their shelf life.

The dispenser 900 may be controlled by the controlling software so that the dispenser 900 only dispenses the toppings as ordered. When the dispenser 900 is in place above a pie or slice that is to be topped by the topping in the dispenser 900, the motor 920 may turn the gears in the gear box 921, which in turn cause the threaded pressure piston 922 to push surface 923. As the surface is pushed down, the food/toppings in container 902 are pushed in and through vertical cutting grid 904. The food/toppings passing through the vertical cutting grid 904 are then sliced by blade 906 and are collected in portion cup 908. Gate 910 is closed to allow portion cup 908 to gather the programmed amount of toppings to be dispensed by dispenser 900. When the gate 910 opens the cut and prepared food 950 is dropped into the dispensing chute and/or dispensed on the pie/slice. The blade 906 may be actuated and/or controlled by blade controller 907. The gate 910 may be actuated and/or controlled by gate controller 908. The piston 922, blade 906, and gate 910 may work in a programmed and coordinated manner to properly dispense freshly cut toppings onto a pizza or slice of pizza.

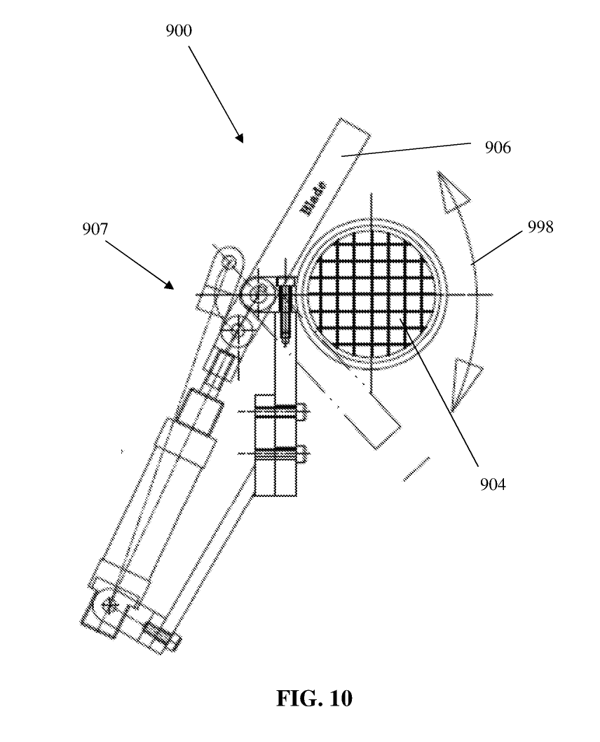

FIG. 10 is an illustration of a top view of one embodiment of a pizza toppings dispenser showing the blade. As shown in FIG. 10, the food dispenser 900, which may be a pizza toppings dispenser, may comprise vertical cutting grid 904, a pivoting blade 906, and blade controller 907. FIG. 10 shows how the blade 906 rotates or pivots 998 to horizontally cut the toppings. The blade controller 907 is shown as a pneumatic actuator, but may be an electric actuator. The blade 906 is shown as rotating or pivoting 998 on a fulcrum, but the blade may have any number of different cutting motions. The blade 906 may be different thicknesses, and in a preferred embodiment is thin and narrow to prevent toppings and other matter from remaining attached to the blade. In an alternate embodiment, the blade 906 may be a wire with securing portions at either end of the wire.

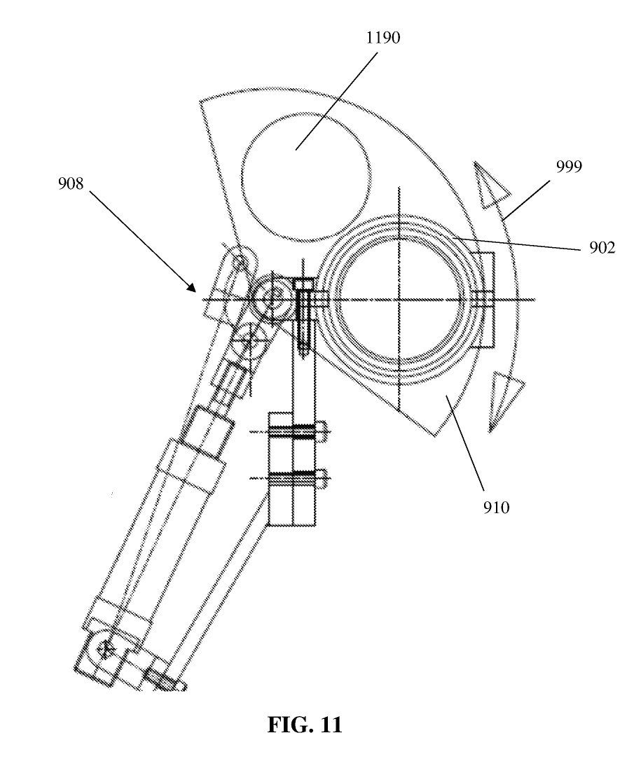

FIG. 11 is an illustration of a top view of another embodiment of a pizza toppings dispenser showing a gate. As shown in FIG. 11, the food dispenser 900, which may be a pizza toppings dispenser, may comprise container 902, gate controller 908 and gate 910, which is in a closed position as shown and is covering vertical cutting grid 904. FIG. 11 shows how the gate 910 rotates or pivots 999 to horizontally move the gate into a temporary open position. In the open position, the hole 1190 is rotated or pivoted 999 to align with the container 902 and vertical cutting grid 904, such that the toppings 950 are released to be dispensed on the pizza or slice. The gate controller 908 is shown as a pneumatic actuator, but may be an electric actuator.

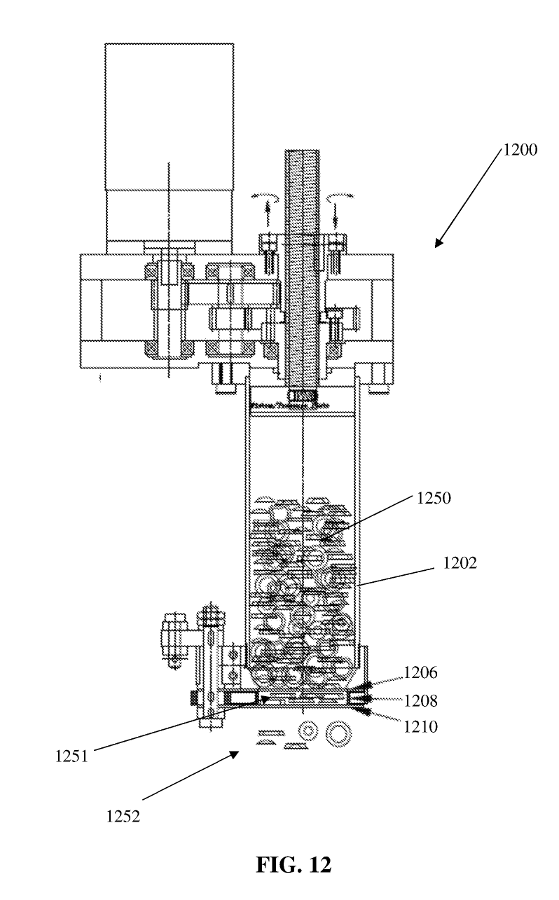

FIG. 12 is an illustration of a side view of another embodiment of a pizza toppings dispenser. FIG. 12 shows that dispenser 1200 may comprise a container 1202, blade 1206, portion space 1208, and gate 1210. The container 1202 may be filed with olives 1250, whole or pre-sliced, as shown. The olives 1251 may be loaded or sliced into portion cup 1208. When the proper amount of olives 1251 are loaded into the dispenser space 1208, or when the dispenser 1200 is properly positioned above the pizza or slice, the gate may open to release the proper amount of olives 1252, as ordered.

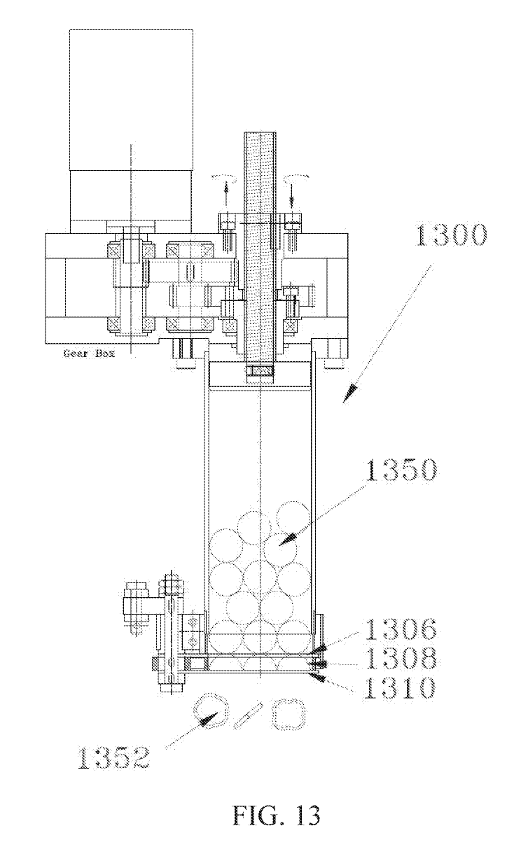

FIG. 13 is an illustration of a side view of another embodiment of a pizza toppings dispenser. FIG. 13 shows that dispenser 1300 may comprise a container 1302, blade 1306, portion space 1308, and gate 1310. The container 1302 may be filed with tomatoes 1350. The tomatoes 1351 may be sliced into portion cup 1308. When the proper amount of tomatoes is loaded into the dispenser space 1308, or when the dispenser 1300 is properly positioned above the pizza or slice, the gate may open to release the proper amount of tomatoes 1352, as ordered.

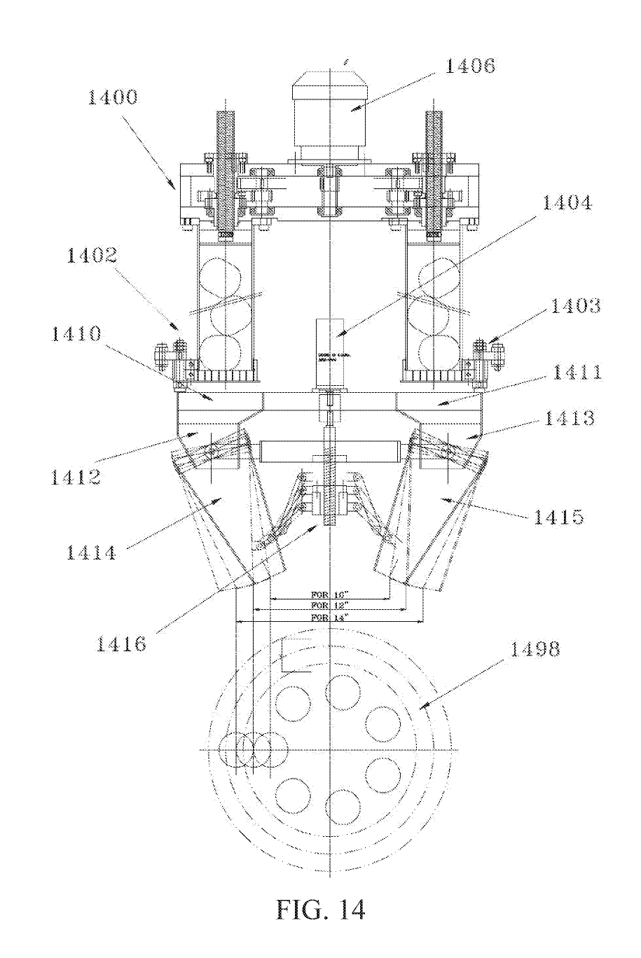

FIG. 14 is an illustration of a side view of one embodiment of a meat/veggie toppings dispensing station. The toppings station may comprise dispensers 1402, 1403, motor 1406, agitation motor 1404, funnels 1410, 1411, chutes 1414, 1415, and agitator 1416. The motor 1406 may rotate the dispensing station 1400 to properly position the chutes 1414, 1415 over the pizza pie 1498, which is shown as potentially being small, medium, or large. Once the toppings are released from the dispensers 1402, 1403, the toppings may pass into funnels 1410, 1411, which funnel the toppings into chutes 1414, 1415. As the toppings pass through and are directed by chutes 1414, 1415, the agitation motor 1404 causes the agitator 1416 to agitate the chutes 1414, 1415, which allows the toppings to be evenly dispersed. Without the agitation, the toppings would simply drop in a large pile, which may make for an unsatisfactory pizza. The agitation may preferably be back and forth, but may also be rotational, omnidirectional, or up and down.

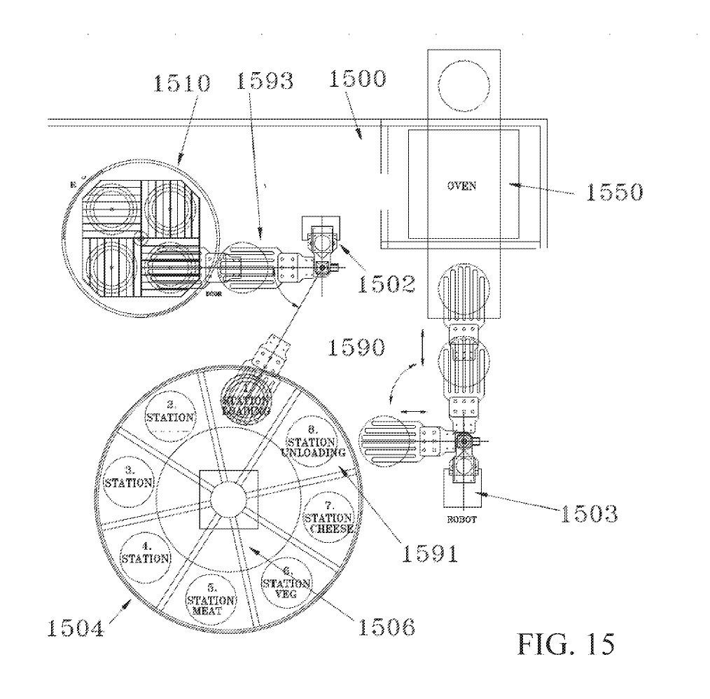

FIG. 15 is an illustration of a top view of another embodiment of the automated pizza making system showing a pick and place handling system. The automated pizza making system 1500 may comprise two automated food handling devices 1502 and 1503, rack 1510, toppings station 1504, and oven 1550. The rotational rack 1510 may have multiple levels, which each may hold four pizzas, slices, or plates. The use of two automated food handling devices 1502 and 1503 may allow the system to more efficiently move the pizzas from rack to toppings to oven. The toppings station 1504 may have a loading position 1590 and unloading position 1591. This may allow more pizzas to be in process on the toppings station.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such that the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An automated pizza making system, comprising:
a computer-based controller;
an ordering system;
one or more automated food handling devices;
one or more racks;
one or more toppings stations; and
one or more ovens;
wherein said one or more automated food handling devices move a plurality of pizzas between said one or more racks, said one or more topping stations, and said one or more ovens, such that said plurality of pizzas are not handled by human hands;
wherein each of said one or more toppings stations comprise one or more sauce stations, one or more cheese stations, and one or more meat/veggie topping stations;
wherein said ordering system is configured to allow a plurality of customer orders of said plurality of made to order pizzas; and
wherein said computer-based controller is configured to process said plurality of customer orders, such that said automated pizza ordering system produces said plurality of made to order pizzas.

2. The automated pizza making system of claim 1, further comprising:
one or more cutting stations.

3. The automated pizza making system of claim 2, further comprising:
one or more packaging stations.

4. The automated pizza making system of claim 3, further comprising:
one or more delivery/pick up stations.

5. The automated pizza making system of claim 4, further comprising:
a dough feeder; and
a dough flattener.

6. The automated pizza making system of claim 4, wherein said one or more automated food handling devices move said plurality of pizzas between said one or more ovens, said one or more cutting stations, and said one or more delivery pick up stations.

7. The automated pizza making system of claim 5, wherein said one or more automated food handling devices move said plurality of pizzas between said dough feeder, said rack, and said one or more toppings stations.

8. The automated pizza making system of claim 7, wherein said dough flattener produces a plurality of flattened dough that is moved by said one or more automated food handling devices to said one or more toppings stations; and
wherein said one or more toppings stations apply at least one pizza topping from said one or more sauce stations, said one or more cheese stations, and said one or more meat/veggie stations, to said plurality of flattened dough, such that said plurality of made or order pizzas are created.

9. The automated pizza making system of claim 8, wherein said plurality of made to order pizzas are moved from said one or more toppings stations to said one or more ovens.

10. The automated pizza making system of claim 8, wherein said plurality of made to order pizzas are moved from said one or more toppings stations to said one or more packaging stations.

11. The automated pizza making system of claim 8, where said ordering system is configured to allow, and said one or more toppings station and said computer-based controller are configured to provide, a plurality of customers to customize said plurality of customer orders, including only applying a sauce, a cheese, and one or more pizza toppings on only a portion of an ordered pizza.

12. The automated pizza making system of claim 4, wherein said ordering system is selected from the group of ordering systems consisting of a website and a mobile software application;
wherein said one or more packaging stations are configured to package said plurality of made to order pizzas in at least one package selected from the group of packages consisting of: cardboard boxes; plastic wrap; and insulating packaging;
wherein said one or more cutting stations are configured to cut said plurality of made to order pizzas in at least two different cut styles.

13. The automated pizza making system of claim 1, wherein each of said one or more racks is multilevel and automated, such that said one or more racks are controlled by said computer-based controller.

14. The automated pizza making system of claim 1, wherein said one or more ovens each comprise a stone conveyor.

15. The automated pizza making system of claim 1, wherein said one or more toppings stations further comprise one or more spice stations.

16. The automated pizza making system of claim 1, wherein each of said one or more meat/veggie toppings stations comprise one or more toppings dispensers and one or more agitated chutes;
wherein each of said one or more toppings dispensers comprises a container, a blade, a portion space, and a gate; and
wherein each of said one or more toppings dispensers dispenses one or more meat/vegetable toppings in an even and consistent manner.

17. An automated pizza making system, comprising:
a computer-based controller;
an ordering system;
one or more automated food handling devices;
one or more racks;
one or more toppings stations;
one or more ovens;
one or more cutting stations;
one or more packaging stations; and
one or more delivery/pick up stations;
wherein said one or more automated food handling devices move a plurality of pizzas between said one or more racks and said one or more topping stations;
wherein said one or more automated food handling devices move said plurality of pizzas between said one or more ovens, said one or more cutting stations, and said one or more delivery pick up stations;
wherein each of said one or more toppings stations comprise one or more sauce stations, one or more cheese stations, and one or more meat/veggie topping stations;
wherein each of said one or more meat/veggie toppings stations comprise one or more toppings dispensers and one or more agitated chutes;
wherein each of said one or more toppings dispensers comprises a container, a blade, a portion space, and a gate;
wherein said one or more toppings stations apply at least one pizza topping from said one or more sauce stations, said one or more cheese stations, and said one or more meat/veggie stations, to a plurality of flattened dough, such that said plurality of made or order pizzas are created;
wherein said ordering system is configured to allow a plurality of customer orders of said plurality of made to order pizzas;
wherein said computer-based controller is configured to process said plurality of customer orders;
wherein said plurality of made to order pizzas are moved from said one or more toppings stations to said one or more ovens;
wherein said plurality of made to order pizzas are moved from said one or more ovens to said one or more cutting stations;
wherein said plurality of made to order pizzas are moved from said one or more cutting stations to said one or more packaging stations;
wherein each of said one or more racks is multilevel and automated, such that said one or more racks are controlled by said computer-based controller.

18. The automated pizza making system of claim 17, further comprising:
a dough feeder; and
a dough flattener;
wherein said one or more ovens each comprise a stone conveyor;
wherein said one or more toppings stations further comprise one or more spice stations.

19. The automated pizza making system of claim 17, wherein said plurality of made to order pizzas are moved from said one or more toppings stations to said one or more ovens by one or more transfer devices selected from the group of transfer devices consisting of: conveyors and automated food handling devices.
